(19) United States
(12) Patent Application Publication
(10) Pub. No.: US 2016/0116906 A1
(43) Pub. Date: Apr. 28, 2016

(54) WORKTOOL CONFIGURATOR FOR MACHINE

(71) Applicant: Caterpillar Inc., Peoria, IL (US)

(72) Inventor: Tazio S. Grivetti, Chillicothe, IL (US)

(73) Assignee: Caterpillar Inc., Peoria, IL (US)

(21) Appl. No.: 14/979,597

(22) Filed: Dec. 28, 2015

(51) Int. Cl. G05B 19/4093

(52) U.S. Cl. CPC G05B 19/40938; G05B 2219/33111; G05B 2219/32128

(57) ABSTRACT

A method of configuring a work tool with a machine is provided. The method includes receiving at least one operational parameter of the work tool by an off board system. The method also includes matching the operational parameter of the work tool with a specification of the machine using a back office system. The method also includes configuring at least one control element of the machine to control at least one function of the work tool. The method includes identifying the work tool connected to the machine by the sensing module. The method also includes retrieving the operational parameters and a pre-defined instruction set stored in the control module corresponding to the identified work tool. The method further includes displaying at least one graphical representation on a display device for each function of the work tool. The method includes controlling the work tool using the at least one control element.

### TECHNICAL FIELD

The present disclosure relates to a work tool for a machine, and more particularly to a method of configuring a work tool with a machine.

### BACKGROUND

A work tool is coupled with a machine to perform various operations such as construction, drilling, excavation, forestry, and material handling. Based on the operation to be performed, a particular work tool may have to be replaced with another work tool. Further, the machine includes a control element such as a joystick or a lever, to control multiple function/activities of the work tool. Control actions of one work tool may vary from the control actions of another work tool previously connected with the machine. Thus, in a scenario where a different work tool is being implemented on the machine, the control element of the machine may have to be configured to control various functions of the work tool. The configuration of the control elements is limited to a pre-defined set of work tools that are pre-configured in the control element during manufacturing. Hence, an end user operating at a customer's end may face difficulties in operating the new work tool.

U.S. Pat. No. 6,061,617, hereinafter referred to as the '617 patent, describes an adaptable controller for work vehicle attachments. The work vehicle has an actuator for attachment and operation of different implements. The actuator is controlled by a control unit. The control unit has an input coupled to a user operated control device. The control unit is coupled to the actuator and activates the actuator in response to the user operated control device. An attachable implement such as a loader bucket is attached to the actuator. An implement data input such as a card slot is coupled to the processor. A portable data storage device, such as a data card, corresponding with the specific implement is inserted in the data input. The data storage device transmits instruction data relating to the specific implement to the implement data input. The controller operates the actuator in accordance to the data read from the data storage device. Alternatively, a sensor may read identification data from an identification indicator on the implement attachment. The controller then selects corresponding instruction data from a memory device. However, the '617 patent does not disclose a method of configuring the work tool with the machine.

### SUMMARY OF THE DISCLOSURE

In one aspect of the present disclosure, a method of configuring a work tool with a machine is provided. The method includes receiving at least one operational parameter of the work tool by an off board system accessed by a user equipment. The method also includes matching the at least one operational parameter of the work tool with a specification of the machine using a back office system. The back office system is in communication with the off board system. The method further includes integrating the at least one operational parameter of the work tool in a database of the back office system and a sensing module of the machine. The method includes storing the at least one operational parameters and a pre-defined instruction set in a control module associated with the machine. The control module is in communication with the sensing module. The method also includes configuring at least one control element of the machine to control at least one function of the work tool based on the at least one operational parameters. The control element is actuated based on inputs received from the control module and the sensing module. The method includes identifying the work tool connected to the machine by the sensing module. The method further includes retrieving the at least one operational parameters and the pre-defined instruction set stored in the control module of the machine corresponding to the identified work tool. The method further includes displaying at least one graphical representation on a display device for each function of the work tool based on the operational parameters and the pre-defined instruction set. The display device is in communication with the control element. The method includes controlling the work tool using the at least one control element based on the graphical representation.

Other features and aspects of this disclosure will be apparent from the following description and the accompanying drawings.

### BRIEF DESCRIPTION OF THE DRAWINGS

FIG. 1 is a block diagram illustrating of an exemplary system for configuring a work tool with a machine, according to an embodiment of the present disclosure;

FIG. 2 is a schematic diagram illustrating a method of configuring the work tool with the machine;

FIG. 3 is a block diagram illustrating the machine coupled with the work tool; and

FIG. 4 is flowchart illustrating a method of configuring the work tool with the machine.

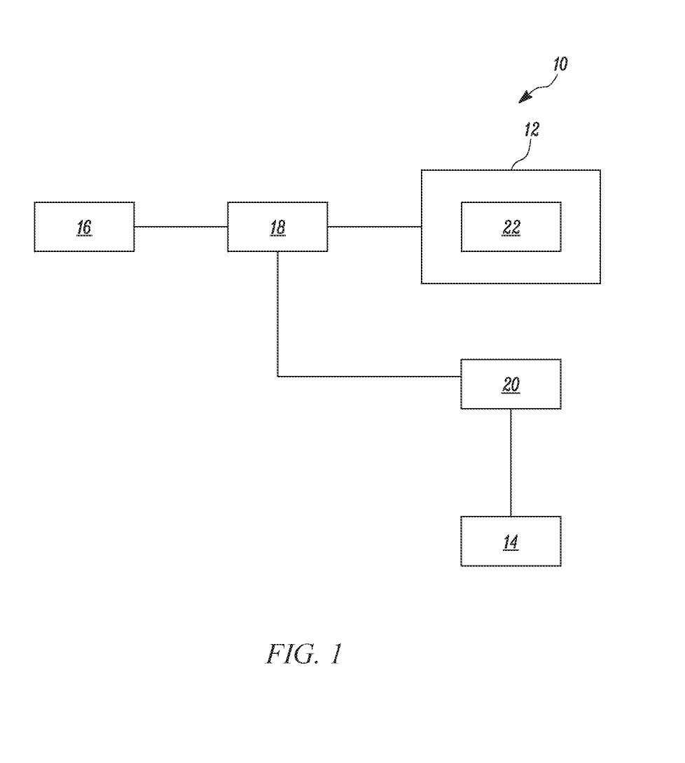

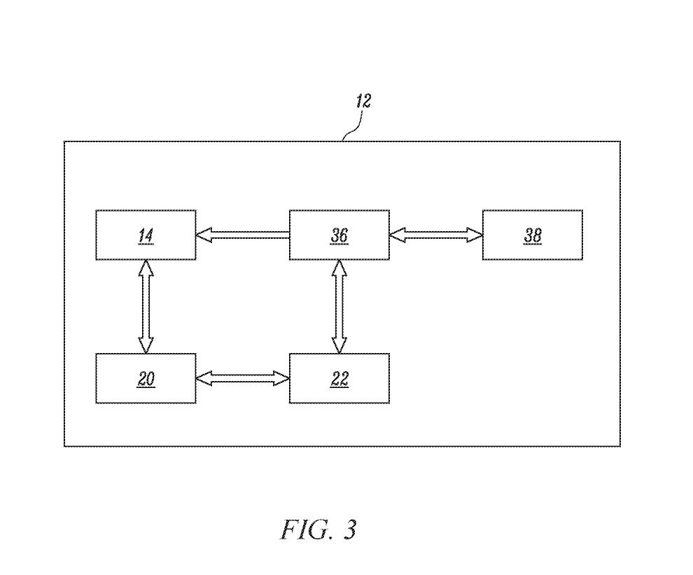

### DETAILED DESCRIPTION

Wherever possible, the same reference numbers will be used throughout the drawings to refer to the same or the like parts. FIG. 1 illustrates a block diagram of an exemplary work tool configurator system 10 for a machine 12, according to one embodiment of the present disclosure. The machine 12 includes a work tool 14 for performing various operations such as construction, drilling, excavation, forestry, and material handling. The work tool 14 may include, but not limited to augers, backhoes, hammers, blades, buckets, thumbs, and the like. The work tool 14 may be controlled by multiple control elements 36 (shown in FIG. 3) such as a joystick or a lever, to perform various operations at a worksite. The work tool 14 may be operated by a hydraulic system (not shown) or a pneumatic system (not shown) of the machine 12, without any limitations.

The work tool configurator system 10 enables configuration of multiple work tools with the machine 12, based on the operation to be performed. In order to configure the work tool 14 with the machine 12, a specification of the machine 12 has to match with a specification of the work tool 14. The specification of the work tool 14 referred to herein may include at least one operational parameter of the work tool 14. The operational parameters may include, but not limited to flow, pressure, temperature, and the like. In one example, the configuration of multiple work tools may be performed during factory settings. Whereas, in another example, the configuration of multiple work tools may be performed after the factory settings. In yet another example, the configuration of multiple work tools may be performed at the worksite where the machine 12 is operating, without any limitations.

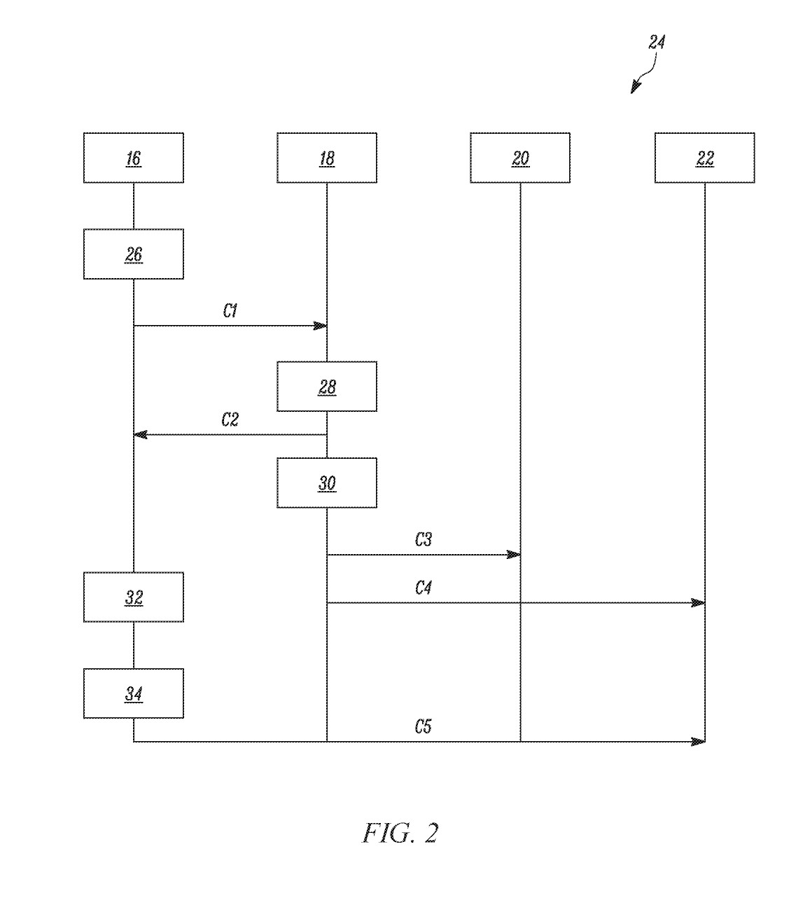

The work tool configurator system 10 includes an off board system 16. The off board system 16 is a software based solution. The off board system 16 enables a user to interact with the work tool configurator system 10. The off board system 16 may include a web application module (not shown). The web application module may be defined based on a web based application. The web based application is enabled to provide a Graphical User Interface (GUI). The GUI of the off board system 16 may be accessed through a user equipment such as portable computing device. The portable computing device may include, but not limited to mobile phone, tablet, laptop, and the like. In one example, the off board system 16 may be accessed by using authentication information, for example, a username and a password. Multiple functional aspects of the off board system 16 will be explained in detail later in this section with reference to FIG. 2.

The work tool configurator system 10 further includes a back office system 18. The back office system 18 is communicably coupled with the off board system 16 via a communication network. The communication network may include any known in the art. The communication network allows communication between the back office system 18 and the off board system 16. The back office system 18 may be a server platform maintained by a manufacturer of the machine 12. For example, the back office system 18 may be a cloud implemented platform hosted in one or more servers accessible to the users over the communication network. Multiple functional aspects of the back office system 18 will be explained in detail later in this section with reference to FIG. 2.

Further, the work tool configurator system 10 includes a sensing module 20. The sensing module 20 may be located on the machine 12 or the work tool 14. In the illustrated embodiment, the sensing module 20 is coupled to the work tool 14. The sensing module 20 is communicably coupled with the back office system 18. The back office system 18 configures the sensing module 20 based on the specification of the work tool 14.

The machine 12 also includes a control module 22. In one example, the control module 22 may be an electronic control module (ECM) that is present on-board the machine 12. The ECM is an embedded system adapted to provide real time regulation of the machine 12 in which it is to be used. The ECM may be adapted to control one or more operating parameters of the machine 12, without limiting the scope of the present disclosure. Further, during the operation of the machine 12, the control module 22 controls the work tool 14 configured with the machine 12. The control module 22 is communicably coupled with the back office system 18. The back office system 18 updates the control module 22 with the specification of the work tool 14 to be connected with the machine 12. The configuration of the work tool 14 using the work tool configurator system 10 is explained in detail in FIG. 2.

FIG. 2 is a schematic diagram 24 for configuring the work tool 14 with the machine 12. The GUI of the off board system 16 receives the operational parameters of the work tool 14 to be configured with the machine 12 from a user as shown at step 26. At a command C1, the off board system 16 transfers the operational parameters of the work tool 14 to the back office system 18. The back office system 18 extracts the operational parameters of the work tool 14 received from the off board system 16. Further, the back office system 18 is enabled to compare the operational parameters of the work tool 14 with the specification of the machine 12 at step 28. In a situation where the operational parameters of the work tool 14 matches with the specification of the machine 12, the back office system 18 provides a feedback to the off board system 16 via a command C2. The feedback from the back office system 18 may include an approval for the configuration of the work tool 14 with the machine 12. However, if the operational parameters of the work tool 14 does not match with the specification of the machine 12, the back office system 18 sends a feedback to the off board system 16 including a denial for the configuration of the work tool 14 with the machine 12, via the command C2.

Further, if the operational parameters of the work tool 14 matches with the specification of the machine 12, then at step 30, the back office system 18 integrates the operational parameters in a database of the back office system 18. The database of the back office system 18 may include a pre-defined instruction set corresponding to each of the work tool 14 to be configured with the machine 12.

The back office system 18 stores the operational parameters and the corresponding pre-defined instruction set in the sensing module 20 at a command C3. Similarly, the back office system 18 stores the operational parameters and the corresponding pre-defined instruction set in the control module 22 of the machine 12 at a command C4. In one example, the pre-defined instruction set may be sent to the control module 22 via telematics. At step 32, the off board system 16 configures a control element 36 (shown in FIG. 3) of the machine 12. In one example, the off board system 16 may configure more than one control elements 36 associated with the machine 12. The control element 36 may include, but not limited to joy stick, levers, wheels, and buttons. The control element 36 of the machine 12 is actuated based on inputs received from the control module 22 and the sensing module 20.

At step 34, the off board system 16 generates at least one graphical representation (not shown) corresponding to at least one function of the control element 36. For instance, the graphical presentation may include direction of movement of the control element 36. The configuration of the control element 36 and generated graphical representation are transferred to the control module 22 of the machine 12 by a command C5. The generated graphical representations are stored at a display device 38 (shown in FIG. 3). The display device 38 displays the graphical representation for each function of the work tool 14. The display device 38 is communicably connected to the control element 36. The display device 38 may include a known in the art output device that visually displays the graphical representations. In one example, the display device 38 may be present at a dashboard of the machine 12. In another example, the display device 38 may be positioned adjacent to the control element 36 of the machine 12, without any limitations.

In one example, multiple work tools may be configured with the machine 12 during factory settings of the machine 12. In such scenarios, the operational parameters corresponding to each of the work tool 14 along with the pre-defined instruction set may be stored in the control module 22 of the machine 12. The operational parameters and the pre-defined instruction set corresponding to each of the work tool 14 may be stored in the control module 22 at an earlier time period. According to operational requirements, an end user can connect and configure any work tool whose data is stored in the control module 22. In another example, the work tool 14 may be configured in real time. In such scenarios, the control module 22 of the machine 12 may be in direct communication with the back office system 18 via any communication modes, such as Wi-Fi or cellular reception.

The configuration of the work tool 14 with the machine 12 will now be explained in detail. FIG. 3 is a block diagram illustrating the machine 12 coupled with the work tool 14. Once the work tool 14 is coupled to the machine 12, the sensing module 20 establishes a connection between the work tool 14 and the machine 12 using a serial communication port or a parallel communication port, known in the art. Further, the sensing module 20 includes a sensor (not shown) and an integrated circuit unit (not shown). The sensor is configured to identify the work tool 14 connected with the machine 12. The integrated circuit unit is configured to store the operational parameters and the pre-defined set of instructions corresponding to each of the work tool 14 configured with the machine 12. In one example, the stored operational parameter and the pre-defined instruction set enables the sensing module 20 to identify the work tool 14 connected with the machine 12. The sensing module 20 sends data corresponding to the operational parameter of the machine 12 based on the pre-defined set of instructions to the control module 22 of the machine 12. The sensing module 20 may be in communication with the control module 22 via any communication medium known in the art.

The control module 22 is configured to determine the function of the work tool 14. The operational parameters and the pre-defined instruction set stored in the control module 22 are retrieved corresponding to the work tool 14 connected with the machine 12. Further, the control module 22 communicates with the control element 36 based on the pre-defined instruction set. In one example, the multiple controlling actions of the control element 36 are updated based on inputs received from the control module 22. An end user operating at a customer's end may control the functions of the work tool 14 using the control element 36. Further, the control element 36 is communicably coupled with the display device 38. Once the control element 36 is actuated, the display device 38 displays the graphical representations corresponding to each of the function of the work tool 14 connected with the machine 12. A number of control actions of the control elements 36, such as the direction of movement of the control element 36, are displayed as the graphical representations on the display device 38.

### INDUSTRIAL APPLICABILITY

The present disclosure relates to the work tool configurator system 10 and a method 40 of configuring the work tool 14 with the machine 12. The work tool configurator system 10 enables the machine 12 to implement a number of different work tools that are developed by third parties. The work tool configurator system 10 provides a platform for third party work tool developers to configure the control elements 36 of the machine 12, based on the specification of the work tool 14. The work tool configurator system 10 improves the utilization of the machine 12 as more than a single work tool can be configured with the machine 12. Further, the present disclosure provides enhanced and an easy to implement method to configure the third party work tool even after the factory settings of the machine 12. In one example, the various work tools that are configured with the machine 12 may be enabled to work without any user instruction.

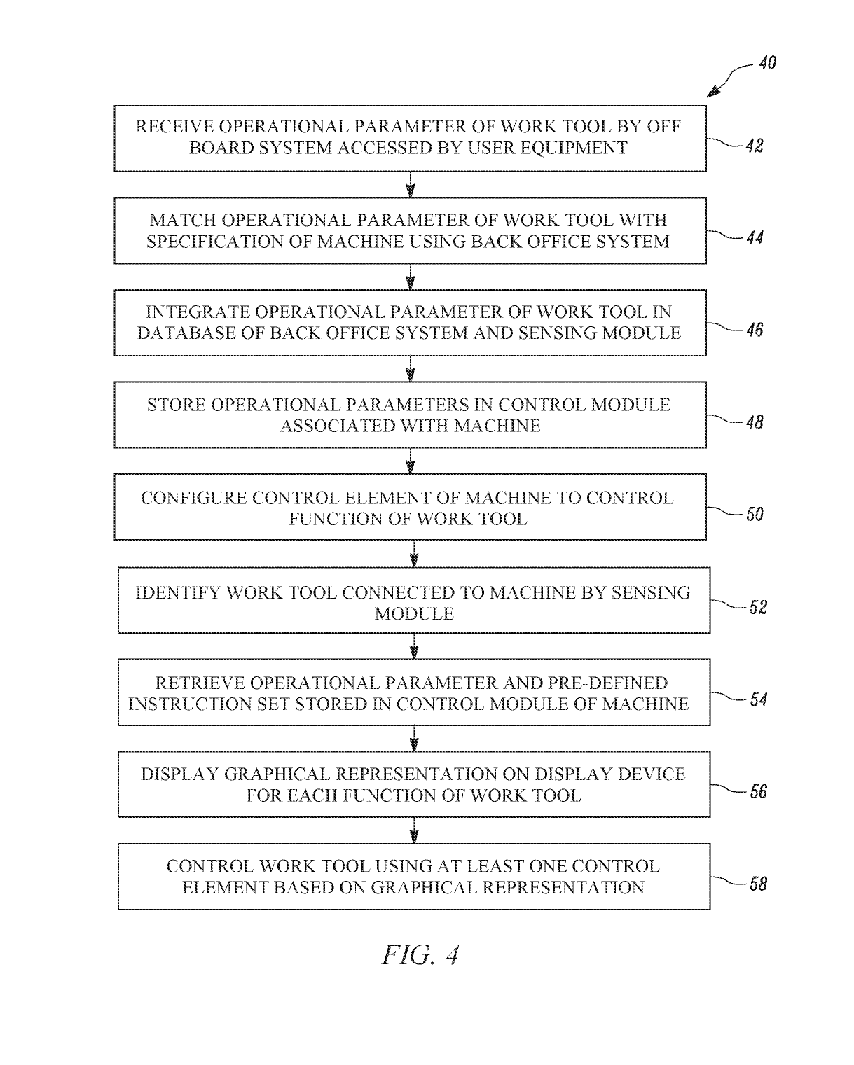

FIG. 4 is diagram flowchart illustrating the method 40 of configuring the work tool 14 with the machine 12. At step 42, the off board system 16 receives the operational parameters of the work tool 14 using the GUI of the off board system 16. At step 44, the received operational parameter of the work tool 14 is matched with a specification of the machine 12 using the back office system 18. If the operating parameters of the work tool 14 matches with the specifications of the machine 12, the operational parameters of the work tool 14 are integrated in the database of the back office system 18 and the sensing module 20 as indicated in step 46. At step 48, the operational parameters are stored in the control module 22 associated with the machine 12. The control module 22 is connected to the control element 36 of the machine 12.

At step 50, the control element 36 of the machine 12 is configured to control at least one function of the work tool 14. When the work tool 14 is connected to the machine 12, the sensing module 20 identifies the work tool 14 connected to the machine 12 at step 52. Further, at step 54 the control module 22 retrieves the operational parameters and the pre-defined instruction set stored in the control module 22 of the machine 12 corresponding to the identified work tool 14. Then, the control element 36 is actuated based on the inputs received from the control module 22 and the sensing module 20. The control element 36 is connected to the display device 38. At step 54, the display device 38 displays the graphical representation of each function of the work tool 14 based on the operational parameters and the pre-defined instruction set. During the operation of the machine 12, the work tool 14 is controlled using the control element 36 based on the graphical representation as indicated at step 56.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of configuring a work tool with a machine, the method comprising:
receiving at least one operational parameter of the work tool by an off board system accessed by a user equipment;
matching the at least one operational parameter of the work tool with a specification of the machine using a back office system, wherein the back office system is in communication with the off board system;
integrating the at least one operational parameter of the work tool in a database of the back office system and a sensing module of the machine;
storing the at least one operational parameters and a pre-defined instruction set in a control module associated with the machine, wherein the control module is in communication with the sensing module;
configuring at least one control element of the machine to control at least one function of the work tool based on the at least one operational parameter, wherein the control element is actuated based on inputs received from the control module and the sensing module;
identifying the work tool connected to the machine by the sensing module;
retrieving the at least one operational parameter and the pre-defined instruction set stored in the control module of the machine corresponding to the identified work tool;
displaying at least one graphical representation on a display device for each function of the work tool based on the operational parameter and the pre-defined instruction set, wherein the display device is in communication with the control element; and
controlling the work tool using the at least one control element based on the graphical representation.
